(19) United States
(12) Patent Application Publication
(10) Pub. No.: US 2024/0421611 A1
(43) Pub. Date: Dec. 19, 2024

(54) EQUALIZATION DEVICE

(71) Applicant: YAZAKI CORPORATION, Tokyo (JP)

(72) Inventor: Takahiro Syouda, Susono-shi (JP)

(21) Appl. No.: 18/814,423

(22) Filed: Aug. 23, 2024

Related U.S. Application Data
(63) Continuation of application No. PCT/JP2023/013869, filed on Apr. 3, 2023.

(30) Foreign Application Priority Data
Apr. 4, 2022 (JP) 2022-062462

(51) Int. Cl. H02J 7/00

(52) U.S. Cl. CPC H02J 7/0019; H02J 7/00711

(57) ABSTRACT

An equalization device includes a single charging and discharging unit selectively connectable to each of a plurality of batteries via a first switch on a positive electrode side and a second switch on a negative electrode side, and a control unit that controls connection states of the first switch and the second switch. The control unit selects one battery among the plurality of batteries according to a predetermined order, and control the connection states of the first switch and the second switch so as to connect a positive electrode side of the charging and discharging unit and contact points connected to the positive electrode of the selected battery, and to connect the negative electrode side of the charging and discharging unit and contact points connected to the negative electrode of the selected battery.

### CROSS-REFERENCE TO RELATED APPLICATIONS

This is a continuation of International Application No. PCT/JP2023/013869 filed on Apr. 3, 2023, and claims priority from Japanese Patent Application No. 2022-062462 filed on Apr. 4, 2022, the entire content of which is incorporated herein by reference.

### TECHNICAL FIELD

The present invention relates to an equalization device.

### BACKGROUND ART

In the related art, in cascade utilization in which a plurality of used batteries are collected and the used batteries are integrated to constitute a storage battery for a large-sized vehicle, a case often occurs in which deterioration states of the respective batteries are different. Here, in general, since a battery capacity of the deteriorated battery is reduced, a power capacity thereof, which can be charged and discharged, is smaller than that of a battery that is not deteriorated. For this reason, in the cascade utilization in which the batteries having different capacities are mixed and are connected in series, the deteriorated batteries are first in a fully-charged state or a fully-discharged state during charging and discharging. Accordingly, it is necessary to stop the charging and discharging even when there are remaining capacities in other batteries, and the battery capacities of all the batteries cannot be used up.

This problem is not limited to the above cascade utilization. For example, a battery pack mounted on a large-sized EV vehicle is also increased in size, and thus uniform temperature increasing is difficult even in the same battery pack, and non-uniformity of temperature occurs in the battery pack. In this state, each of respective battery cells of the vehicle used for a long period of time indicates deterioration in accordance with temperature environment, and thus the deterioration states (capacities) are different. Further, in a case of an EV vehicle provided with a plurality of battery packs, it is difficult to maintain the same temperature environment between the packs, and thus the deterioration states (capacities) are different. In addition, even in a case in which new batteries are used, capacities of the batteries may be different due to variations in manufacturing.

Further, due to differences in charge-discharge efficiency (the ratio of a discharging capacity to a charging capacity) between the batteries having different states, a large deviation in a state of charge (SOC) between the batteries occurs by repeating the charging and discharging, and the battery capacities that can be used as a battery system are reduced.

FIG. 3 is a conceptual diagram illustrating an example of a case in which the charging and discharging are repeated when a plurality of (three) batteries having different deterioration states are connected in series. In FIG. 3, an upper end of a hatched portion in each of batteries B1 to B3 indicates the SOC in a fully-charged state, and a lower end of the hatched portion indicates the SOC in a fully-discharged state.

First, it is assumed that the three batteries B1 to B3 are connected in series. It is assumed that among the three batteries B1 to B3, the third battery B3 is most deteriorated, the second battery B2 is next deteriorated, and the first battery B1 is not deteriorated.

In this case, the third battery B3 has a lower charge-discharge efficiency than that of the first and second batteries B1 and B2, and has a small capacity that can be discharged with respect to a charged capacity. Accordingly, when the charging and discharging are repeated, the first and second batteries B1 and B2 shift in a direction in which the SOC increases. As an example, the first and second batteries B1 and B2 can be discharged by only 90 with respect to the charging of 100 under influence caused by the third battery B3, and shift to a high SOC side by repeating the charging and discharging. This shift eventually leads to a state in which the charging and discharging cannot be performed in all of the plurality of batteries B1 to B3.

That is, the first and second batteries B1 and B2 shift to the high SOC side from an initial stage to a middle stage of a charging-discharging cycle in which the charging and discharging are repeated. Further, at a last stage of the charging-discharging cycle, the first and second batteries B1 and B2 are close to SOC 100%, and only a slight amount of capacity can be charged. Accordingly, the third battery B3 also cannot be charged to SOC 100%, and eventually reaches a state in which neither charging nor discharging is possible.

In order to solve problems, there has been proposed an equalization device that detects inter-terminal voltages of the batteries and performs equalization based on the detected inter-terminal voltages (see Patent Literature 1). However, an equalization control based on the detected inter-terminal voltages of the batteries is complicated, and a control load increases.

Therefore, there has been proposed an equalization device in which capacitors can be connected in parallel separately from a plurality of batteries connected in series, and each capacitor is switched to be mutually connected with the adjacent batteries connected in series (see Patent Literature 2). According to the equalization device, the equalization can be performed without requiring a complicated control. However, the equalization device described in Patent Literature 2 requires only the same number of capacitors for voltage equalization as the batteries, so that an increase in cost cannot be avoided.

On the other hand, there have been proposed equalization devices in which charging and discharging are repeated between a plurality of batteries and one capacitor (see Patent Literatures 3 and 4). Since the number of capacitors is one in these equalization devices, an increase in cost can be restrained.

### CITATION LIST

### Patent Literature

Patent Literature 1: JP3858893B
Patent Literature 2: JP2019-75862A
Patent Literature 3: JP2000-166113A
Patent Literature 4: JP2001-178008A

### SUMMARY OF INVENTION

However, in the equalization devices described in Patent Literatures 3 and 4, there is a possibility that an external short circuit occurs in the batteries due to a switch configuration thereof, which leads to a failure in the devices. For example, in the equalization device disclosed in Patent Literature 3, when a switch SW1 and a switch SW3 are turned on at the same time, a Battery 1 is in a short-circuited state.

An object of the present invention is to provide an equalization device capable of restraining an increase in cost and reducing a possibility of device failure without requiring a complicated control.

In order to achieve the above object, an equalization device according to the present invention has the following features.

An equalization device includes:
a single charging and discharging unit that is selectively connectable to each of a plurality of batteries connected in series via a first switch on a positive electrode side and a second switch on a negative electrode side; and
a control unit that controls connection states of the first switch and the second switch, in which
the first switch connects the positive electrode side of the charging and discharging unit to one of a plurality of contact points respectively connected to positive electrodes of the plurality of batteries,
the second switch connects the negative electrode side of the charging and discharging unit to one of a plurality of contact points respectively connected to negative electrodes of the plurality of batteries, and
the control unit is configured to select one battery among the plurality of batteries according to a predetermined order, and control the connection states of the first switch and the second switch so as to connect the positive electrode side of the charging and discharging unit and the contact point connected to the positive electrode of the selected battery, and to connect the negative electrode side of the charging and discharging unit and the contact point connected to the negative electrode of the selected battery.

The current limiting unit is a pulse width modulation (PWM) control circuit using a switching circuit and an inductor.

### BRIEF DESCRIPTION OF DRAWINGS

FIG. 1 is a configuration diagram illustrating a battery system including an equalization device according to the present embodiment;

FIG. 2 is a conceptual diagram illustrating an example of a case in which charging and discharging are repeated when an equalization control is performed by the equalization device according to the present embodiment; and

FIG. 3 is a conceptual diagram illustrating an example of a case in which the charging and discharging are repeated when a plurality of (three) batteries having different deterioration states are connected in series.

### DESCRIPTION OF EMBODIMENTS

Hereinafter, the present invention will be described with reference to a preferred embodiment. The present invention is not limited to the following embodiment, and the embodiment can be appropriately modified without departing from the gist of the present invention. In the embodiment described below, there may be portions in which illustration and description of a part of a configuration are omitted, and it is needless to say that a known or well-known technique is appropriately applied to the details of an omitted technique within a range in which no contradiction with the contents described below occurs.

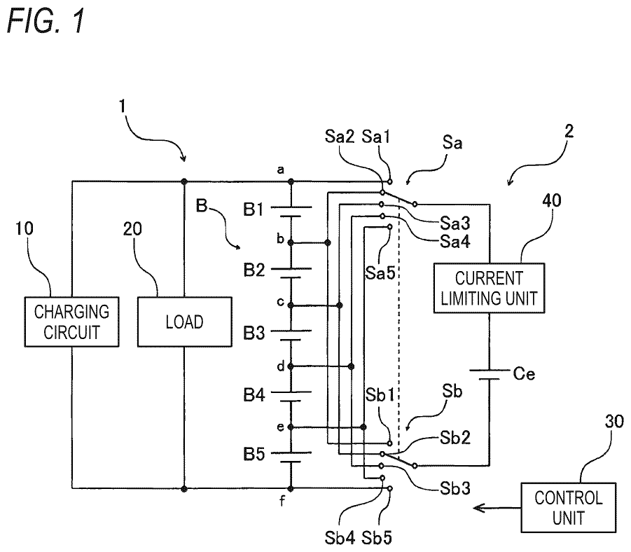

FIG. 1 is a configuration diagram illustrating a battery system including an equalization device according to the present embodiment. A battery system 1 illustrated in FIG. 1 includes a battery group B, a charging circuit 10, a load 20, and an equalization device 2. The equalization device 2 includes a single charging and discharging unit Ce, first and second switches Sa and Sb, a control unit 30, and a current limiting unit 40.

The battery group B includes a plurality of batteries B1 to B5 connected in series. As each of the batteries B1 to B5, for example, a used battery (which may be a unit cell or a module including a plurality of cells) used in an in-vehicle application or the like and collected is used. The batteries B1 to B5 are not limited to the used batteries.

The charging circuit 10 charges the plurality of batteries B1 to B5, and performs, for example, constant voltage (CV) charging after constant current (CC) charging. For example, the charging circuit 10 may be connected to a commercial power source via an AC/DC converter, and may be connected to another DC power source. The control unit 30 controls the charging circuit 10 by using these power sources, and controls charging of the plurality of batteries B1 to B5.

The load 20 is driven by using power from the plurality of batteries B1 to B5, and corresponds to a motor in an EV vehicle or the like, for example. The single charging and discharging unit Ce is an equalization capacitor that can be charged and discharged in order to perform an equalization operation to be described later, a capacitor, or a secondary battery.

The first switch Sa is a switch unit provided on a positive electrode side of the charging and discharging unit Ce. The first switch Sa is a so-called rotary switch, one end thereof is connected to the positive electrode side of the charging and discharging unit Ce, and the other end thereof is connected to one of a plurality of contact points Sa1 to Sa5. The first contact point Sa1 is connected to a connection point a connected to a positive electrode of the first battery B1. The second contact point Sa2 is connected to a connection point b connected to a positive electrode of the second battery B2. The third contact point Sa3 is connected to a connection point c connected to a positive electrode of the third battery B3. The fourth contact point Sa4 is connected to a connection point d connected to a positive electrode of the fourth battery B4. The fifth contact point Sa5 is connected to a connection point e connected to a positive electrode of the fifth battery B5.

The second switch Sb is a switch unit provided on a negative electrode side of the charging and discharging unit Ce. Similarly to the first switch Sa, the second switch Sb is also implemented by a so-called rotary switch. One end of the second switch Sb is connected to the negative electrode side of the charging and discharging unit Ce, and the other end thereof is connected to one of a plurality of contact points Sb1 to Sb5. The first contact point Sb1 is connected to the connection point b connected to a negative electrode of the first battery B1. The second contact point Sb2 is connected to the connection point c connected to a negative electrode of the second battery B2. The third contact point Sb3 is connected to the connection point d connected to a negative electrode of the third battery B3. The fourth contact point Sb4 is connected to the connection point e connected to a negative electrode of the fourth battery B4. The fifth contact point Sb5 is connected to a connection point f connected to a negative electrode of the fifth battery B5.

The control unit 30 controls the entire battery system 1, and in the present embodiment, the control unit 30 has a function of controlling connection states of the first switch Sa and the second switch Sb. The control unit 30 controls these connection states so as to equalize inter-terminal voltages of the plurality of batteries B1 to B5. Specifically, the control unit 30 respectively connects the contact points (one of Sa1 to Sa5, and one of Sb1 to Sb5) respectively connected to the positive electrode and the negative electrode of one selected battery (one of B1 to B5) among the plurality of batteries B1 to B5, to the positive electrode side and the negative electrode side of the charging and discharging unit Ce. That is, when the first battery B1 is selected, the control unit 30 connects the first switch Sa to the first contact point Sa1 and connects the second switch Sb to the first contact point Sb1. Accordingly, a positive electrode of the charging and discharging unit Ce is connected to the positive electrode of the first battery B1, and a negative electrode of the charging and discharging unit Ce is connected to the negative electrode of the first battery B1. Similarly, when one of the batteries B2 to B5 is selected, the control unit 30 connects the first switch Sa to corresponding one of the second contact point Sa2 to the fifth contact point Sa5, and connects the second switch Sb to corresponding one of the second contact point Sb2 to the fifth contact point Sb5.

Further, the control unit 30 sequentially changes the batteries B1 to B5 to be selected. Specifically, the control unit 30 first selects the first battery B1, connects the first switch Sa to the first contact point Sa1, and connects the second switch Sb to the first contact point Sb1. Next, the control unit 30 selects the second battery B2, connects the first switch Sa to the second contact point Sa2, and connects the second switch Sb to the second contact point Sb2. Thereafter, the control unit 30 selects the third to fifth batteries B3 to B5 in order, and respectively connects the first switch Sa and the second switch Sb to the third contact points Sa3 and Sb3, the fourth contact points Sa4 and Sb4, and the fifth contact points Sa5 and Sb5 in this order in a time division manner. In addition, when the connection of the first switch Sa and the second switch Sb from the first contact points Sa1, Sb1 to the fifth contact points Sa5, Sb5 is set to one round, the control unit 30 repeats the connection several rounds.

Accordingly, by using a potential difference between the charging and discharging unit Ce and the n-th (n is an integer of 1 or more and 5 or less) battery Bn, the equalization device 2 according to the present embodiment performs the charging and discharging therebetween. That is, in the case of VBn<VCe when the inter-terminal voltage of the n-th battery Bn is set to VBn and a voltage of the charging and discharging unit Ce is set to VCe, a current discharged from the charging and discharging unit Ce is charged to the n-th battery Bn, and a charging capacity of the n-th battery Bn increases. On the other hand, in the case of VBn>VCe, a current discharged from the n-th battery Bn is charged to the charging and discharging unit Ce, and the charging capacity of the n-th battery Bn decreases.

Accordingly, the control unit 30 can equalize the inter-terminal voltages of the plurality of batteries B1 to B5 via the charging and discharging unit Ce by repeating the connection states of the first switch Sa and the second switch Sb several rounds.

In particular, in the equalization device 2 according to the present embodiment, the first switch Sa and the second switch Sb are implemented by rotary switches. Accordingly, for example, even when corresponding one of the contact points Sa1 to Sa5 or corresponding one of the contact points Sb1 to Sb5 remain closed due to a switch failure, a device failure due to an external short circuit of the batteries B1 to B5 does not occur.

The current limiting unit 40 is implemented by a circuit for limiting a current, and is provided, for example, between the positive electrode of the charging and discharging unit Ce and the first switch Sa. The current limiting unit 40 is not particularly limited as long as the current limiting unit 40 can limit the current such that no excessive current flows between the positive electrode of the charging and discharging unit Ce and the first switch Sa, the current limiting unit 40 may be an active circuit such as a resistor and an inductor, and may be a pulse width modulation (PWM) control circuit using a switching circuit and an inductor.

Here, in a case in which the current limiting unit 40 is not provided, the potential difference between the charging and discharging unit Ce and the n-th battery Bn may increase when a control initial stage of the equalization device 2 itself or a time until switch switching completes one round is long. When the potential difference is large, there is a possibility that a current associated with voltage equalization increases and exceeds an allowable current of the n-th battery Bn or the charging and discharging unit Ce. However, the equalization device 2 according to the present embodiment includes the current limiting unit 40, and thus it is possible to equalize the inter-terminal voltages of the plurality of batteries B1 to B5 within an allowable range of the n-th battery Bn or the charging and discharging unit Ce.

Next, an operation of the equalization device 2 according to the present embodiment will be described. An equalization control of the inter-terminal voltages of the plurality of batteries B1 to B5 is executed at an appropriate timing. When the equalization control is executed, the control unit 30 first connects the first switch Sa to the first contact point Sa1 and connects the second switch Sb to the first contact point Sb1. Accordingly, the first battery B1 is charged and discharged by the charging and discharging unit Ce via the connection points a and b.

Next, the control unit 30 connects the first switch Sa to the second contact point Sa2, connects the second switch Sb to the second contact point Sb2, and then performs the charging and discharging between the second battery B2 and the charging and discharging unit Ce via the connection points b and c. Thereafter, the control unit 30 respectively connects the first switch Sa and the second switch Sb to the third to fifth contact points Sa3 to Sa5 and the third to fifth contact points Sb3 to Sb5 in order, and performs the charging and discharging between each of the third to fifth batteries B3 to B5 and the charging and discharging unit Ce in order.

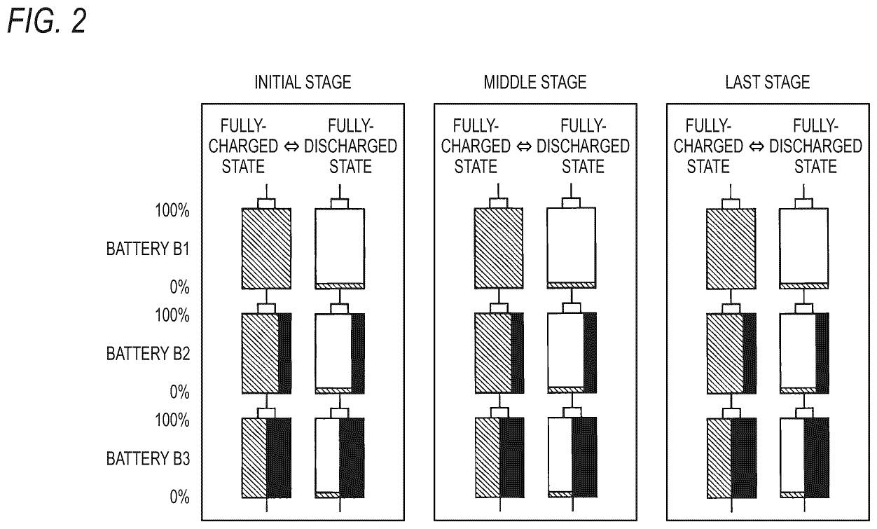

Thereafter, the control unit 30 repeats the above operation several rounds. Accordingly, the inter-terminal voltages of the plurality of batteries B1 to B5 are equalized. As a result, a fully-charged state and a fully-discharged state of each of the plurality of batteries B1 to B5 are shown in FIG. 2.

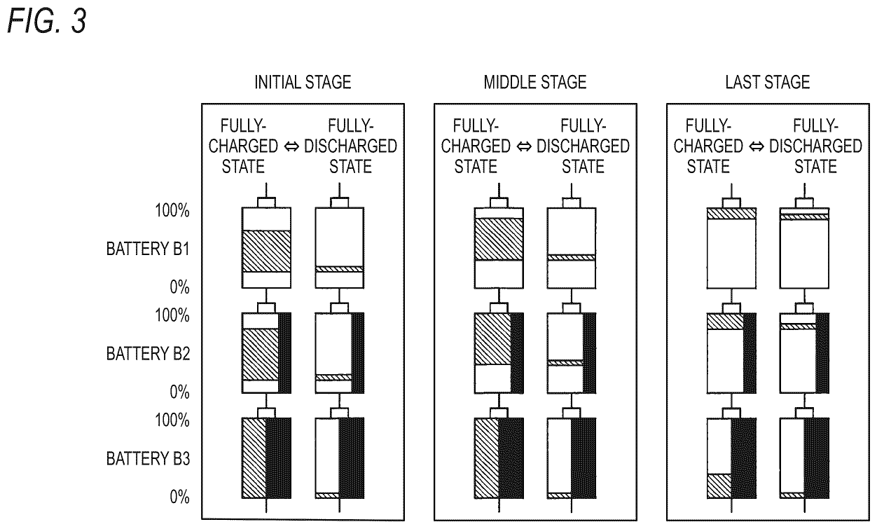

FIG. 2 is a conceptual diagram illustrating an example of a case in which the charging and discharging are repeated when the equalization control is performed by the equalization device 2 according to the present embodiment. Although the five batteries B1 to B5 are shown in FIG. 1, the example shown in FIG. 2 will be described by using the first to third batteries B1 to B3 as examples. In addition, in the example shown in FIG. 2, a deterioration state, and indication of SOC at upper and lower ends of a hatched portion of each of the first to third batteries B1 to B3 are the same as those described with reference to FIG. 3.

First, in the case of the example shown in FIG. 3, the equalization control is not performed, and thus when the first to third batteries B1 to B3 are charged, the first to third batteries B1 to B3 are charged by an amount corresponding to an available capacity of the third battery B3 that is most deteriorated. On the other hand, when the control unit 30 executes the equalization control according to the present embodiment, the inter-terminal voltages of the first to third batteries B1 to B3 are equalized. That is, upper end positions of the hatched portions of the first to third batteries B1 to B3 are uniformed. Therefore, as shown in an initial stage of the charging cycle in FIG. 2, all the batteries B1 to B3 are charged to SOC 100%. At this time, the inter-terminal voltages of all the batteries B1 to B3 are equalized, and thus the control unit 30 only needs to perform a charging control by the charging circuit 10 until a charging termination voltage reaches a target value, and a simple control is easily achieved. The same applies to a case in which the load 20 is driven and discharged from the plurality of batteries B1 to B3.

In this way, the inter-terminal voltages of all the batteries B1 to B3 are equalized by the equalization control, and thus the total capacity of each of the batteries B1 to B3 can be appropriately used up. The control unit 30 only needs to continue the discharging until a discharging termination voltage reaches a target value.

As described above, according to the equalization device 2 of the present embodiment, the control unit 30 executes the control of respectively connecting the first switch Sa and the second switch Sb to the contact points Sa1 to Sa5 and the contact points Sb1 to Sb5 respectively connected to the positive electrode and the negative electrode of the selected corresponding one among the batteries B1 to B5. Further, the control unit 30 switches the batteries B1 to B5 to be selected in order so as to perform the charging and discharging between the charging and discharging unit Ce and each of the batteries B1 to B5. Therefore, it is not necessary to measure the inter-terminal voltage of each of the batteries B1 to B5, and the equalization can be performed by using the single charging and discharging unit Ce. In addition, the first switch Sa and the second switch Sb respectively connect the charging and discharging unit Ce with one of the plurality of contact points Sa1 to Sa5 and one of the plurality of contact points Sb1 to Sb5, and thus the exclusive switch connection is achieved, no external short circuit occurs in the batteries B1 to B5 even when an abnormality occurs in the first switch Sa or the second switch Sb, and the possibility of device failure is reduced. Therefore, it is possible to restrain an increase in cost and reduce the possibility of device failure without requiring a complicated control.

In addition, when the battery group B is manufactured or when the battery is replaced, the batteries B1 to B5 having different charging states can be incorporated without any adjustment.

In addition, the current limiting unit 40 is further provided that limits the current when the charging and discharging are performed between the charging and discharging unit Ce and each of the batteries B1 to B5, and thus it is possible to reduce the possibility that the current associated with the voltage equalization between the charging and discharging unit Ce and the batteries B1 to B5 increases and exceeds the allowable current of each of the batteries B1 to B5 or the charging and discharging unit Ce, as in the initial stage of the start of equalization, for example.

The present invention is not limited to the embodiments described above, and various modifications can be adopted within the scope of the present invention. For example, the present invention is not limited to the embodiment described above, and modifications, improvements, and the like can be made appropriately. In addition, materials, shapes, sizes, numbers, arrangement positions, and the like of the components in the embodiment described above are freely selected and are not limited as long as the present invention can be achieved.

For example, in the embodiment described above, the number of batteries B1 to B5 is five or three as an example, but the present invention is not particularly limited thereto, and two, four, six or more batteries may be used. Further, the battery group B described above may be equally divided into groups, a positive electrode side of a group may be connected to the first switch Sa, a negative electrode side thereof may be connected to the second switch Sb, and the charging and discharging may be performed between the charging and discharging unit Ce and the group by sequentially switching the groups to be selected.

Further, in the embodiment described above, the control unit 30 controls the connection states of the first switch Sa and the second switch Sb such that the charging and discharging using the charging and discharging unit Ce are performed in the order of the battery B1, the battery B2, the battery B3, the battery B4, and the battery B5. However, as long as the inter-terminal voltages of the batteries B1 to B5 are equalized, the batteries B1 to B5 may be selected in an order different from that in the present embodiment.

The present application is based on a Japanese patent application (Japanese Patent Application No. 2022-062462) filed on Apr. 4, 2022, and the contents thereof are incorporated herein by reference.

### INDUSTRIAL APPLICABILITY

The equalization device according to the present invention is capable of restraining an increase in cost and reducing a possibility of device failure without requiring a complicated control. The present invention having such an effect can be applied to, for example, a battery system mounted on an automobile and the like.

What is claimed is:

1. An equalization device comprising:
a single charging and discharging unit that is selectively connectable to each of a plurality of batteries connected in series via a first switch on a positive electrode side and a second switch on a negative electrode side;
a control unit that controls connection states of the first switch and the second switch; and
a current limiting unit that limits a magnitude of a current flowing between the charging and discharging unit and each of the plurality of batteries,
wherein
the first switch connects the positive electrode side of the charging and discharging unit to one of a plurality of contact points respectively connected to positive electrodes of the plurality of batteries,
the second switch connects the negative electrode side of the charging and discharging unit to one of a plurality of contact points respectively connected to negative electrodes of the plurality of batteries,
the control unit is configured to select one battery among the plurality of batteries according to a predetermined order, and control the connection states of the first switch and the second switch so as to connect the positive electrode side of the charging and discharging unit and the contact point connected to the positive electrode of the selected battery, and to connect the negative electrode side of the charging and discharging unit and the contact point connected to the negative electrode of the selected battery, and
the current limiting unit is a pulse width modulation (PWM) control circuit using a switching circuit and an inductor.
